(19) United States
(12) Patent Application Publication
(10) Pub. No.: US 2012/0264330 A1
(43) Pub. Date: Oct. 18, 2012

(54) SHIELDED CONNECTOR

(75) Inventors: Emanuel G. Banakis, Naperville, IL (US); Jerry D. Kachlic, Glen Ellyn, IL (US)

(73) Assignee: MOLEX INCORPORATED, LISLE, IL (US)

(21) Appl. No.: 13/503,911

(22) PCT Filed: Oct. 26, 2010
(86) PCT No.: PCT/US10/54114

§ 371 Date: Jun. 27, 2012

Related U.S. Application Data
(60) Provisional application No. 61/255,072, filed on Oct. 26, 2009.

(51) Int. Cl. H01R 13/60

(52) U.S. Cl. 439/569

(57) ABSTRACT

A connector includes a multi-port shield configured to reduce EMI. A housing is positioned inside the shield and includes one or more projections extending from a first face, the projections aligned with each port. A vertical wall is provided on the first face of the housing. Apertures in the vertical wall are aligned with the projections. The vertical wall helps reduce the amount of EMI generated by the connector.

This application claims priority to U.S. Provisional App. No. 61/255,072, filed Oct. 26, 2009 and to U.S. Provisional App. No. 61/255,366, filed Oct. 27, 2009, both of which are incorporated herein by reference in their entirety.

### BACKGROUND OF THE INVENTION

1. Field of the Invention

The present invention relates to the field of connectors, more specifically to the field of high data rate capable I/O connectors.

2. Description of Related Art

Shielded connectors have been used in external applications (e.g., applications in which the connector acts as an interface external to the system in which it is mounted) so as to provide acceptable electromagnetic interference (EMI) and signal performance. One issue that has been noted is that as the frequencies of signaling increase, additional power is often required in order for the system to function over a similar distance. Furthermore, the use of higher signaling frequencies tends to increase the sensitivity of the connector to external noises in those higher frequencies. In addition, the terminals in the connector tend to act as radiators and emit EMI. As EMI generally needs to be carefully controlled, shielded connectors face a number of challenging issues. Thus, certain individuals would appreciate improvements in shielded connector designs.

### BRIEF SUMMARY OF THE INVENTION

A connector includes cage that extends around two three sides and a top and includes a u-brace that defines a first and second port in a front face of the connector. The first and second port both extend from the front face to separate a projection in a housing that is mounted inside the connector. A vertical wall may be positioned on both projections and be configured so that it engages the cage on three sides. The u-brace may include a first and second wall and a folded section may be positioned on both the first and second wall adjacent the front face. A center plug can be positioned between the two folded sections so as to provide good electrical isolation. In an embodiment, both the vertical wall and the folded section features can both be included in connector. In another embodiment, just one of these features can be included in the connector.

### BRIEF DESCRIPTION OF THE DRAWINGS

The present invention is illustrated by way of example and not limited in the accompanying figures in which like reference numerals indicate similar elements and in which:

FIG. 1 illustrates a perspective view of an embodiment of a receptacle.

FIG. 1A illustrates a perspective view of a cross-section of the receptacle depicted in FIG. 1.

FIG. 1B illustrates an exploded perspective view of the receptacle depicted in FIG. 1.

FIG. 2 illustrates a perspective view of an embodiment of a housing with a vertical wall.

FIG. 3 illustrates an elevated front view of the housing depicted in FIG. 2.

FIG. 4 illustrates a perspective view of an embodiment of a housing and a U-brace.

FIG. 4A illustrates a partially exploded view of the embodiment picked in FIG. 4.

FIG. 5 illustrates a perspective exploded view of an embodiment of a housing and a vertical wall.

FIG. 6 illustrates elevated side view of a cross-section of the receptacle depicted in FIG. 1.

FIG. 7 illustrates an enlarged elevated side view of the cross-section depicted in FIG. 6.

FIG. 8 illustrates a perspective view of an embodiment of a U-brace.

### DETAILED DESCRIPTION OF THE INVENTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

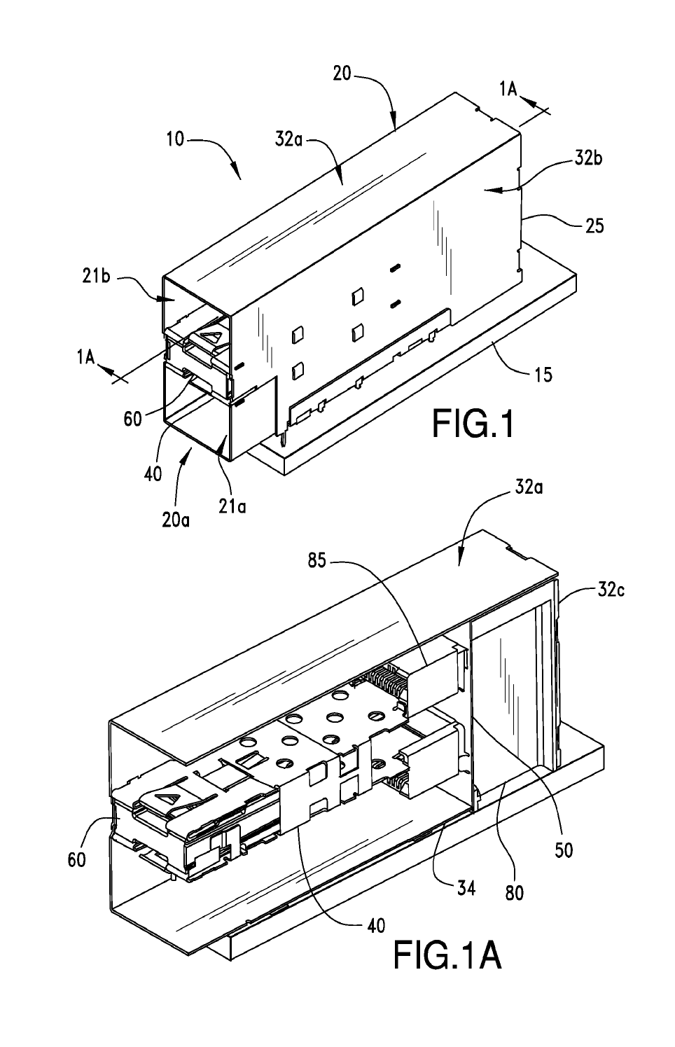

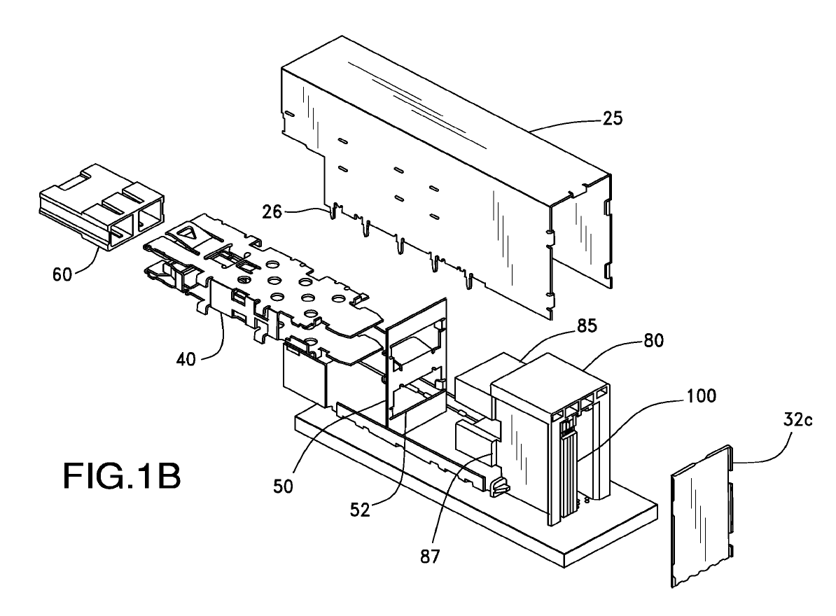

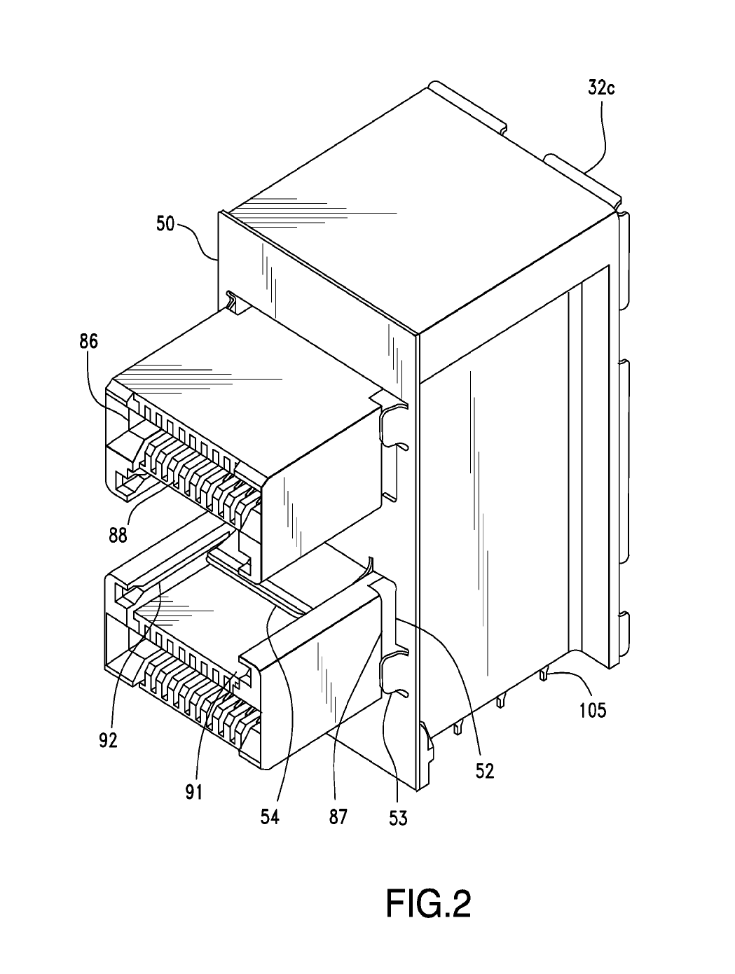

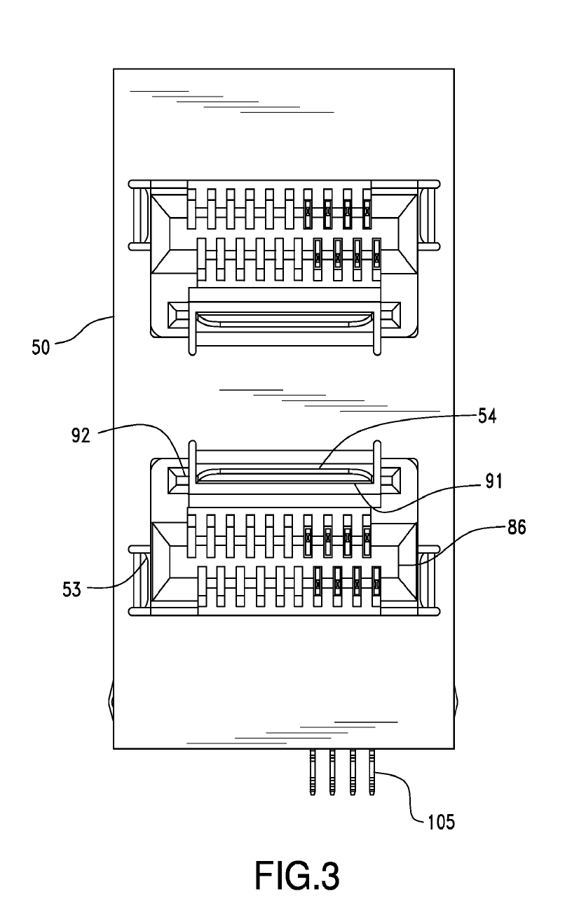

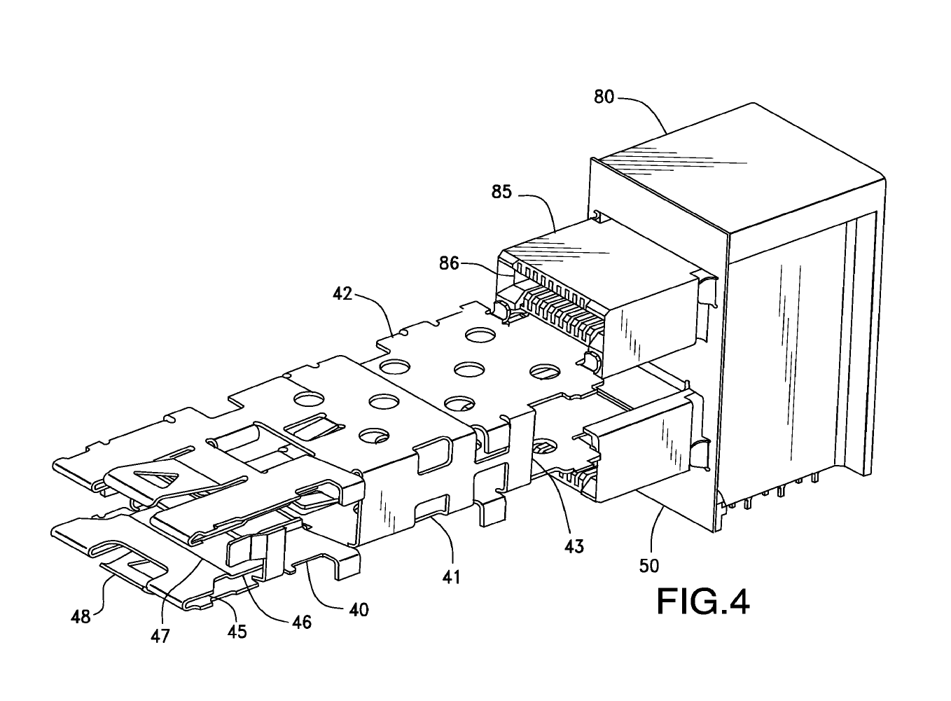

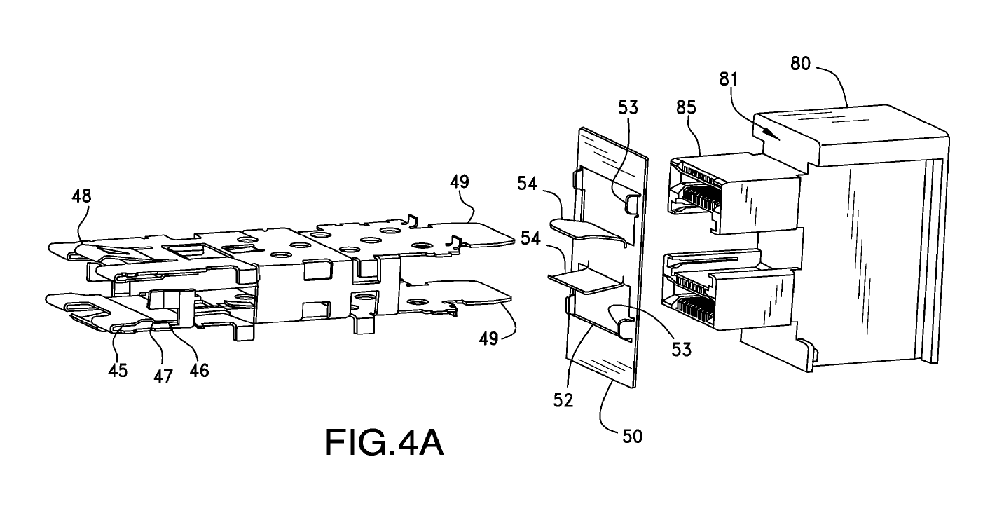

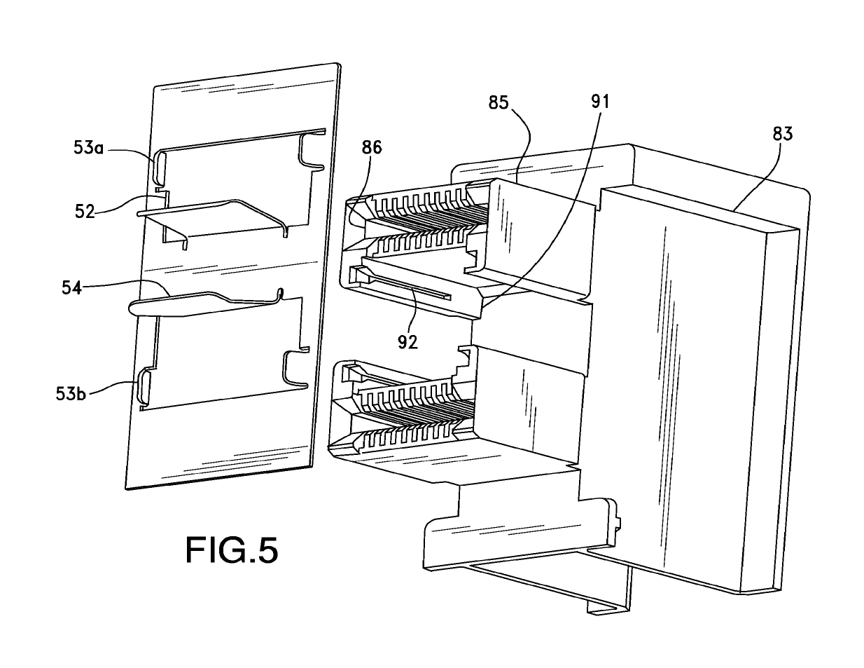

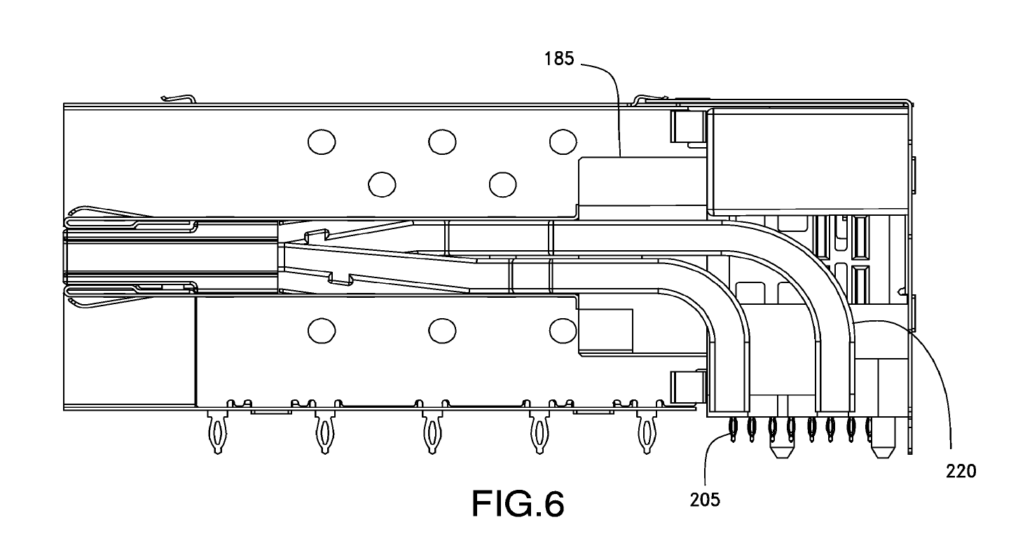

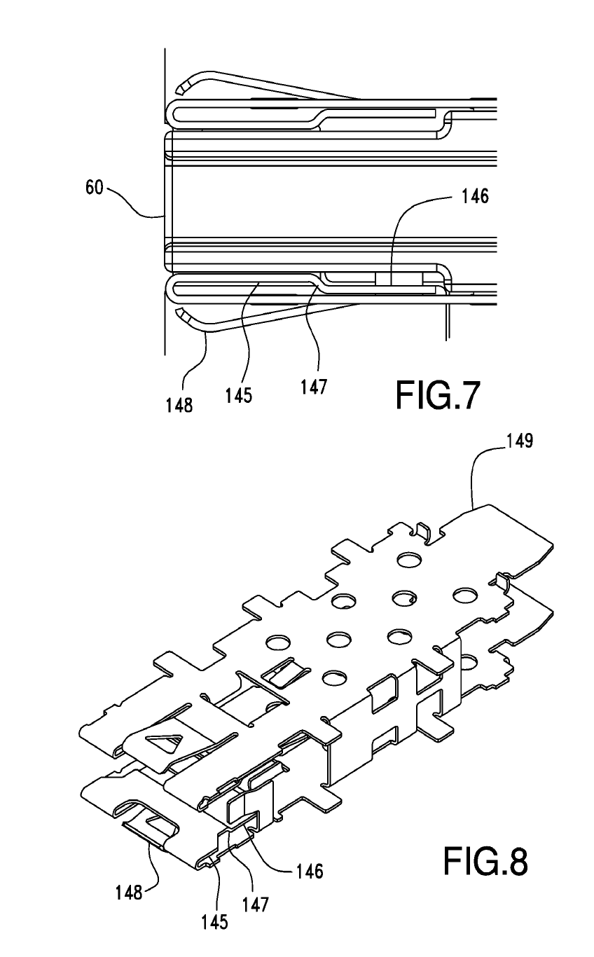

FIGS. 1-8 illustrate various features that may be incorporated into a connector 10 that is mounted on a printed circuit board (PCB) 15. As can be appreciated, the connector 10 includes a cage 20 that includes a cover 25, a bottom plate 34 and a u-brace 40 that helps define a first port 21a and a second port 21b. The connector 10 thus depicts a stacked connector configuration.

As can be appreciated, one issue that exists in such designs is the desire to shield from external signals and noise while minimizing the emission of EMI from the connector 10. To help improve the ability of the cage 20 to isolate and act as a shield, a vertical wall 50 is positioned near a front face 81 of a housing 80. The vertical wall 50 has an aperture 52 that mounts over projection 85 (each projection including one or more card slots) so that the vertical wall 50 can be positioned on or close to the front face and retention tabs 53 engage notch 87 of the housing 80. This helps prevent spurious signals (e.g., noise) from entering and interfering with signals carried over terminals 105 in the connecter 10 as well as reducing the radiating of spurious signals (e.g., EMI) from the terminals. To further improve the shielding, the vertical wall 50 can include a flange 54 that engages shoulder 49 of the u-brace 40. Thus, in an embodiment there is a substantially continuous enclosure for each port 21a, 21b. It should be noted that the vertical wall flange 54 is positioned in a channel 91 while the shoulder 49 is positioned in groove 92. This type of construction helps ensure the flange 54 securely engages the shoulder 49.

For certain designs the vertical wall 50 may not be necessary and improvements in shielding can be accomplished by improving shielding at a front face 20a of the connector 10. The u-brace 40 may also include a folded section 45 to help shield each port 21a, 21b. The folded section 45 is configured to engage center plug 60, which may be formed in a manner so as to act as a shield (e.g., the center plug may be formed of a metal). The center plug 60 is positioned between two folded sections 45 so that an EMI shield is formed therebetween. To help support the folded section 45, a lip 46 can rest against wall 41, 42 and an angled section 47 can be positioned between the lip 46 and the folded section 45. As depicted, the folded section extends substantially the entire width of the port. Consequentially, when the center plug 60 is inserted between the upper and lower folded sections it forms a substantially continuous shield.

While either the vertical wall or the u-brace may be used individually, in an embodiment, both the vertical wall 50 and the u-brace 50 with the folded section 45 may be included in the same connector. Such a combination has the benefit of using the vertical wall 50 to reduce the EMI energy that is transmitted into the port from the housing (and the associated terminals 105 which may be positioned in wafers, as is known, if the terminals are in a stacked configuration as depicted) while ensuring good electrical connection between an inserted plug module (not shown) and walls 41, 42 of the individual ports. Furthermore, the folded sections act to further reduce the amount of EMI energy transmitted out of the port.

It should be noted that light pipes 220 can also be included. If the light pipes are included in combination with the vertical wall 50, then apertures can be provided in the vertical wall 50 so that the light pipes can pass between a supporting circuit board and the front face 20a of the connector 10. Furthermore, the center plug 60 can also include apertures or areas configured to transmit light emitted from the light pipes.

As depicted, a single stacked connector is illustrated with a single vertical wall. It is also contemplated that the vertical wall could be made into two or more parts. As can be further appreciated, in a ganged connector configuration a single vertical wall could be used with each U-brace. However, it is also possible to have a single wall span across multiple housings if the cage was so configured. The depicted arrangement of a vertical wall that spans two stacked ports has the benefit of ensuring good EMI performance without requiring a substantial change to existing cage design.

In addition, to the above discussed features, the number of apertures on sides of the cage 20 can be reduced to reduce the EMI that is transmitted into or out of the connector. For example, as depicted the sides are substantially devoid of apertures. Thus, a number of features that could provide improved shielding are disclosed herein. As can be appreciated, these features can be used in combination with each other so as to provide the desired level of EMI shielding.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

We claim:

1. A connector, comprising:
a cage having a first and second port;
a housing positioned in the cage and having a first face, the housing having a first projection and a second projection on the first face, the first projection aligned with the first port and the second projection aligned with the second part; and
a vertical wall positioned on the first face and configured to be electrically coupled to the cage, the vertical wall having a first aperture aligned with the first projection and a second aperture aligned with the second projection.

2. The connector of claim 1, wherein the cage has a top and a bottom and the vertical wall extends substantially between the top and bottom.

3. The connector of claim 2, wherein the connector further includes a u-brace, the u-brace positioned between the first and second projection.

4. The connector of claim 3, wherein the u-brace includes a folded section.

5. The connector of claim 4, wherein the connector includes a plug configured to be inserted into the u-brace, the plug configured to engage the folded section.

6. The connector of claim 5, wherein the vertical wall includes a flange that engages the u-brace.
